(19) United States
(12) Patent Application Publication
(10) Pub. No.: US 2014/0358881 A1
(43) Pub. Date: Dec. 4, 2014

(54) Search Infrastructure Supporting Identification, Setup and Maintenance of Machine to Machine Interactions

(71) Applicant: Broadcom Corporation, Irvine, CA (US)

(72) Inventors: Yasantha Nirmal Rajakarunanayake, San Ramon, CA (US); James Duane Bennett, Hroznetin (CZ); Wael William Diab, San Francisco, CA (US)

(73) Assignee: Broadcom Corporation, Irvine, CA (US)

(21) Appl. No.: 13/956,305

(22) Filed: Jul. 31, 2013

Related U.S. Application Data
(60) Provisional application No. 61/829,831, filed on May 31, 2013.

(51) Int. Cl. G06F 17/30

(52) U.S. Cl. CPC G06F 17/30864
USPC 707/706; 707/722

(57) ABSTRACT

A technique in which autonomous machine-to-machine interactions are identified, setup and maintained between machines by utilizing a registry that may be searched to identify a registered machine. The search may be for a particular target machine or for content. By identifying a target machine, the registry may provide an address to connect two machines for the two machines to interact, such as the download of content stored on one of the machines.

### CROSS REFERENCE TO RELATED APPLICATION

The present U.S. Utility Patent Application claims priority pursuant to 35 U.S.C. §119(e) to U.S. Provisional Patent Application No. 61/829,831, entitled “Search Infrastructure Supporting Identification, Setup and Maintenance of Machine to Machine Interactions,” filed May 31, 2013, which is incorporated herein by reference in its entirety for all purposes.

### BACKGROUND

1. Technical Field

The embodiments of the present disclosure relate to communications between machines and, more particularly, to autonomous machine-to-machine interactions after searching for a target machine or content to establish a machine-to-machine communication link.

2. Description of Related Art

Communication infrastructures rely on a number of search techniques and/or search engines to allow a user to search for various content accessible to the user via a network, such as the Internet. In a typical content search, a user inputs a search term or phrase for use with a search engine, such as Google® or Yahoo®, to initiate a search. The search engine utilizes a crawler to navigate through various web sites accessible via the Internet or, alternatively, searches through cached data sites containing a list of recently searched or popular web sites. The search engine provider then uses some form of filtering to categorize and order the found sites for presentation to the searcher (e.g. the user). The user may then further narrow the search by entering a new search term or phrase and/or narrowing the original search parameter.

In a typical user-initiated search described above, the user is the active initiator of the search and the search for content is typically limited to finding content that matches the search term or phrase. A list of site locations is provided to the user in way of Uniform Resource Locators (URLs). The user then can navigate to a site by clicking on the provided URL to access the site and, when permitted, to access the content. In some instances, the user may input the search term or phrase and delay the performing of the search. However, the search is based on identifying a site location (e.g. Internet Protocol (IP) address) that is accessible that contains the content matching the search term or phrase.

Furthermore, when a search is performed strictly on a Personal Computer (PC) platform, the accessed sites typically also reply based on the same PC format. Although, some amount of display format may be adjusted at the user end to accommodate for different displays (e.g. showing a web page on a large computer monitor versus showing the web page on a small screen of a smartphone), content adjustments are not made based on a particular device identification and/or configuration. Thus, smartphones that run one type of streaming video program may not be able to support a second type of streaming video program. Unless, the search parameter identified this fact, the search may not return a valid result or return a result in an incorrect format, which may not be presentable.

The above-described search procedure typically requires a user-initiated search for conducting a further user input to adjust the search. In some instances, machine-to-machine communications are practiced where autonomous machine interactions may occur. However, generally, these machine-to-machine interactions are conducted between known machines that are configured within a closed network. Typically, the connection is over a private network or a virtual network that provides security. Thus, such machine-to-machine communications are not based on machines conducting machine searches over a public network, such as the Internet.

### BRIEF DESCRIPTION OF THE DRAWINGS

FIG. 1 shows a system diagram of an example network connecting a number of different machines and a machine-based search engine, in which machine-to-machine interactions are implemented.

FIG. 2 shows a system diagram for registering machines in a registry and supporting a search conducted from a first machine to find and identify a second machine that contains content for transfer to the first machine.

FIG. 3 shows a system diagram for registering machines in a registry and supporting a search conducted from a first machine to find and identify a second machine that contains content for transfer to the first machine, but utilizing a proxy to maintain anonymity.

FIG. 4 is an example diagram of a registry that contains a list of registered machines and supporting a content search, in which the content is associated with a machine registered in the registry.

FIG. 5 is an example diagram of a search in which a registry that contains a list of registered machines is searched along with a separate search for content that is associated with a machine registered in the registry.

FIG. 6 is an example flow diagram in conducting a search to identify and locate a target machine registered in a machine registry.

FIG. 7 is an example flow diagram in conducting a search to identify and locate a target content for a machine registered in a machine registry.

FIG. 8 is an example block diagram of a machine that initiates a search for machine-to-machine interaction.

FIG. 9 is an example block diagram of a machine-based search engine and registry that supports a search for machine-to-machine interaction.

FIG. 10 is a system diagram illustrating an example of content transfer via machine-to-machine interaction, when a target machine is identified by using the registry that supports machine-based searching.

FIG. 11 is a system diagram illustrating an example of content transfer via machine-to-machine interaction, when target content is identified in one or more machines by using the registry that supports machine-based searching.

FIG. 12 is a system diagram illustrating an example of content transfer via machine-to-machine interaction in an industrial setting.

FIG. 13 is a system diagram illustrating an example of content transfer via machine-to-machine interaction in a medical setting.

FIG. 14 shows a system diagram of an example network integrating the machine-based search engine and registry with web-based content searching.

### DETAILED DESCRIPTION

The embodiments described below may be practiced in a variety of networks that utilize wired, wireless or optical connections, or any combinations thereof. One or more such networks may include the Internet and/or the World Wide Web (WWW). The network may be public, private, virtual or any combination thereof. The devices on the network may utilize one or more communication protocols to communicate via the network, including various IEEE (Institute of Electrical and Electronic Engineers) specified protocols, ITU (International Telecommunication Union) specified protocols, as well as others, and utilizing various addressing schemes, including Internet Protocol (IP) addressing.

Furthermore, the disclosure makes references to a machine or machines herein. A machine may be a device, robot, industrial machine or any user equipment utilized for performing a task or assist in the performance of a task. Some of the machines that are described herein include mobile phones, tablet computers, personal computers (PCs), and set-top boxes. However, other devices not described herein may be used in the machine-to-machine interaction described in this disclosure. The term machine and device may be used interchangeably herein.

Additionally, as used herein, the term “automatic” refers to an action with no user intervention, whereas the term “automated” refers to an action by a machine that may be in response to a user intervention, such as a user triggering an action or the machine reacting to a response from a user. Also, the term “autonomous” is defined herein as an action or response that is triggered by a machine. The term “unassociated machine(s)” refers to one or more machines that do not have prior relationship and are often unknown to each other. Even after search or other linking between machines, the machines may remain unknown to one another due to proxy and/or anonymity. Although implementation examples are noted herein, the implementation is not limited to such disclosed embodiments.

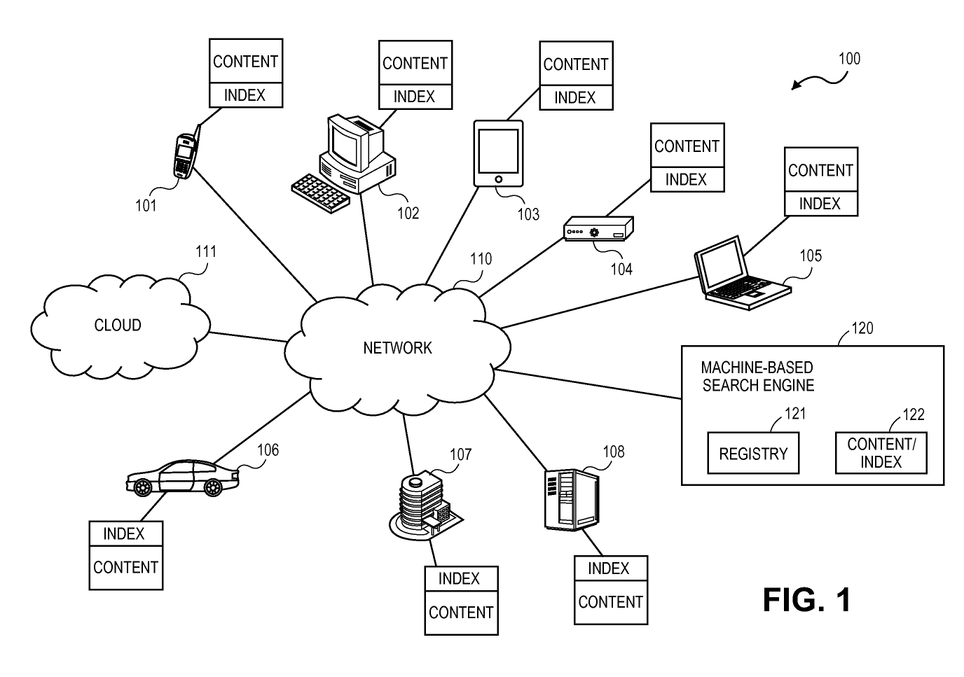

FIG. 1 shows a system diagram of an example network connecting a number of different machines and a machine-based search engine, in which machine-to-machine interactions are implemented. FIG. 1 shows a system 100 that includes a variety of devices (or machines) 101-108 configured to operate with a network 110, which may be one or more of a variety of networks, as described above. The devices are also referred to as machines. In the particular example for system 100, device 101 is a mobile phone (e.g. cell phone, smartphone, etc.), device 102 is a personal computer (PC), device 103 is a tablet computer, device 104 is a set-top box, device 105 is a notebook computer, device 106 is a device affixed in a vehicle (e.g. a communication device or Global Positioning System (GPS) with dual link in a vehicle), device 107 is a unit in a building or a factory, and device 108 is a server. Devices 101-108 also contain content that may be used by the corresponding device or shared with other devices. The content may be indexed, such as by labeling, metadata, etc., so that such index may be shared or searched. The index may be any type of categorization scheme, where the content of a particular device may be easily searched. In some devices, such an index may not be present. Furthermore, one or more devices 101-108 may store some or all of the actual content in a remote location (e.g. cloud storage) as represented by cloud storage (cloud) 111 at a remote location.

Within system 100, some of the devices may be fixed to particular locations, while other devices may be mobile. For example, device 107 in a building and PC 102 may be fixed to a location, while mobile phone 101 and vehicle 106 are typically mobile. However, for system 100, devices 101-108 have the ability to connect to other devices via network 110, whether mobile or fixed.

In system 100, one of the devices 101-108 has the capability to communicate with other devices via network 110 by machine-to-machine connection, in order to interact with a target machine. The interaction may be automatic (initiated by a machine) or may be automated (initiated by a user action). The interaction may be to search for a particular target device, in order to communicate with the target device. The interaction may be to search for a particular content and locating the target device associated with the searched content. The interaction may be for some other function.

In order for devices 101-108 to participate in machine-to-machine interactions, devices 101-108 register with a registry 121 of a machine-based search engine 120. It is to be noted that search engine 120 may be one apparatus or may be multiple devices at different locations. When a particular device registers with registry 121 as a registered machine, the registering device provides information pertaining to the particular device as part of the device profile data. The information provided by a device (e.g. devices 101-108) may vary depending on the requirements of the particular registry. Generally, a unique identifying information about the registering device is provided. The device identification (ID) may be a component ID (such as a processor ID) of a component in the device, a manufacturer provided ID, or some other ID that uniquely identifies the particular device from other devices.

Along with the device ID, an address of the device is also provided. This address may be an Internet Protocol (IP) address, mobile communication address, or some other address to be used to connect to the device. In some instances where the device is mobile, the address may change over time as the device changes locations. In this event, the device may update the address information in registry 121 so that other devices may seek connection with the registered device. Address data, operational characteristics and other operational or configuration data may be provided as status data related to that device. In some instances, profile and status data may be combined together as profile-status data for the particular machine.

Additionally, characteristics that pertain to the registering device may be registered as well. The characteristics may be provided by the device itself or generated by search engine 120 or a combination of both. The characteristics identify various information regarding the registered device, including, but not limited to, type or status of the device, capabilities of the device, name of the owner (or user) of the device, services provided by the device, security requirements of the device, anonymity of the device, authorized accesses to the device, digital rights management (DRM) requirements of the device, content information for content associated with the device, etc. A variety of other information or constraints may be registered as one of the characteristics that pertain to the registering device. Further disclosure is provided below in reference to the characteristics of the registering device.

Therefore, devices 101-108 register with registry 121 as registered machines so that registry 121 contains a list of devices with unique ID, corresponding addresses to connect to the devices, and corresponding characteristics associated with the registered devices. It is to be noted that other information may be retained in registry 121 corresponding to the particular registered device.

For example, content or content index associated with a device may also be included as part of the characteristics or, alternatively, in a separate database that is linked to the registry. Thus, machine-based search engine 120 may also include a content storage separate from the registry that contains content or index of the content associated with the registering device. The content or content index (content/index) is stored in storage 122 and linked to registry 121. Further examples are disclosed below. Registry 121 may be a single registry or a distributed registry. Likewise storage 122 may be a single unit or a distributed storage.

Once devices 101-108 register with registry 121 as a registered machine, a registered device may access the registry to locate another registered device. Some identifying feature, such as device ID or a particular feature of the characteristics may be searched to identify the target device. Identifying feature of the target device may be part of the profile data associated with the target device. Similarly, content may be searched to locate a target content and the content linked to a registered device. Once the device is identified, the address associated with that device (which may be part of the status data for the device) may be used to access the device.

For example, if an owner/user of tablet 103 wants to locate his or her grandmother's mobile phone 101 to interact with the grandmother's device, the owner/user of tablet 103 may use the registry to locate mobile phone 101, provided both devices are registered with registry 121 as registered machines. If the owner/user of tablet 103 does not know the device ID or address of mobile phone 101, the owner/user of tablet 103 may use other information retained as one of the characteristics to locate mobile phone 101 as a search parameter. For example, if the characteristics contained a field for the name of the owner/user of the registered device, owner/user of tablet 103 may use functions of search engine 120 to search the name field of the characteristics to locate grandmother's name. Once the name is found, the device ID and address is cross-referenced and the information provided to the owner/user of tablet 103. Once grandmother's tablet is identified, further operations then may allow owner/user of tablet 103 to connect and interact with mobile phone 101. The interaction may be to communicate with grandma via mobile phone 101 or it may be to link to mobile phone 101 to download photos contained in mobile phone 101, or elsewhere contained (e.g. cloud 111), but associated as content of mobile phone 101.

In another example, the owner/user of tablet 103 may be trying to locate grandmother's photos but is unaware of grandmother's devices and is also not able to locate her devices. However, if the grandmother had uploaded the photos or index of photos for sharing to storage 122, then a content search using a content search parameter may be performed by owner/user of tablet 103 to search for content that might identify the photos to be belonging to grandma. Once the content/index is located, then grandma's tablet ID and address may be cross-referenced. Assuming that the storage contained only the index of content of mobile phone 101 that grandmother wants to share (e.g. photos), once the search locates the grandma's index, the owner/user of tablet 103 may now interact to download the photos from grandma's mobile phone 101.

Since the machine-to-machine interactions of system 100 may be performed autonomously by the devices, in order to locate grandmother's mobile phone 101, the search operation may be configured by the device. For example, owner/user of tablet 103 may program or use an application (app) to search for grandmother's devices by name or search by content. The search function may be performed by tablet 103 to access registry 121 and/or storage 122 to perform the search by search engine 120. If any other functions are required, such as obtaining permission to download the photos from mobile phone 101, the machine operations may perform that operation without user input. Thus, if mobile phone 101 is not currently accessible, tablet 103 and/or search engine 120 may delay the access operation until mobile phone 101 is available for accessing its contents. It is to be noted that various other scenarios may be implemented and practiced. Further description and examples are disclosed below.

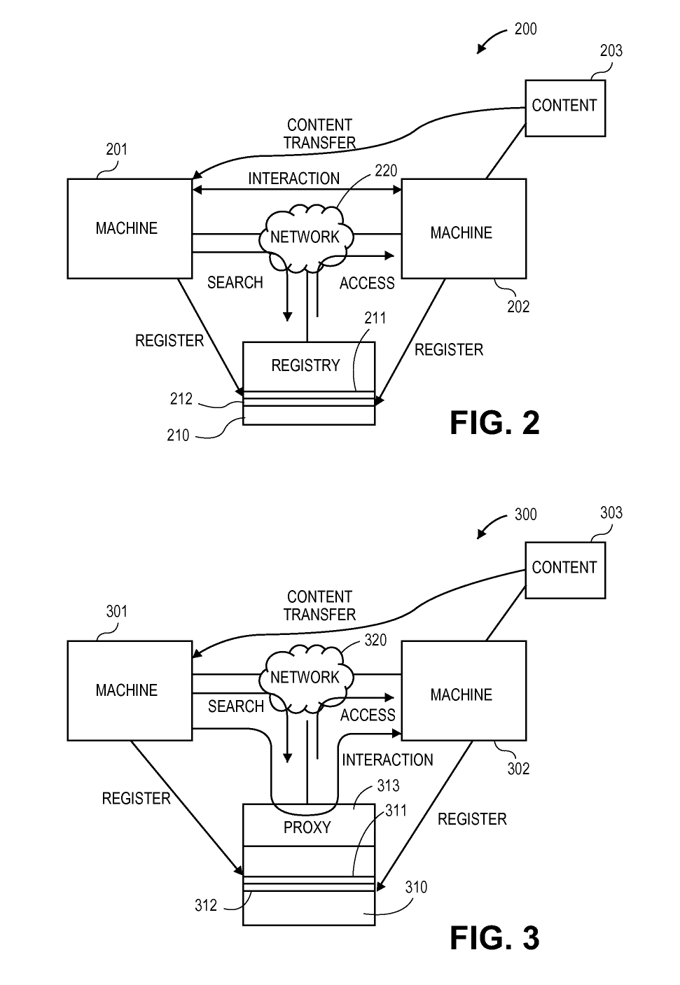

FIG. 2 shows a system diagram for registering machines in a registry and supporting a search conducted from a first machine to find and identify a second machine that contains content for transfer to the first machine. FIG. 2 shows a system 200, which may be part of system 100 of FIG. 1, where machine 201 interacts with machine 202 via network 220 and registry 210. Machines 201 and 202 may be any of the devices shown in FIG. 1 or any other device. Machine 201 registers with registry 210 either directly or via network 220. Likewise machine 202 registers with registry 210 either directly or via network 220. An entry 211 in registry 210 contains device ID, address and characteristics of machine 201 and an entry 212 contains device ID, address and characteristics of machine 202.

As noted above, the characteristics may be provided by the device itself or generated by the search engine or a combination of both. The characteristics identify various information regarding the registered device, including, but not limited to, type of the device (e.g. machine 201, 202), capabilities of the device, name of the owner (or user) of the device, services provided by the device, security requirements of the device, anonymity of the device, authorized accesses to the device, digital rights management (DRM) requirements of the device, content information or index for content associated with the device, status of the device (e.g. if the device is active or asleep), certain software or app running on the device, etc. A variety of other information or constraints may be registered as one of the characteristics as well. Registry 210 may have a plurality of such device entries in a list, table or other categorizing structures.

FIG. 2 shows an example of operation in which machine 201 accesses registry 210 to search for a particular target device or search for a content and the corresponding target device for the content. A search may be performed by machine 201 to registry 210 to locate a particular target device, when the device ID of the target device is known. Otherwise, a search may be conducted, such as a name search, if such element is registered for the device characteristics. Alternatively, a search may be made for a particular target content either in the registry, associated storage or database. As noted above, a content index may be used. In some instances, the search engine may access the various devices noted in the registry to search the content or content index of the individual devices, although this would be time consuming. However, in some instances, the registry may contain a reasonable amount of registered devices to perform a search of the content index of individual devices within an acceptable time frame.

The search by machine 201 in registry locates the target device as machine 202. Then, an output is generated containing a profile data and/or status data of machine 202, so that an access may be provided to machine 202 via network 220 for the two machines to interact. Assuming that the example interaction is to download content 203 that is located at machine 202, the interaction permits machine 201 to access machine 202 to download the content. The profile data and/or status data of machine 202 may assist in establishing the link and/or configuring the interaction.

FIG. 3 shows a system diagram for registering machines in a registry and supporting a search conducted from a first machine to find and identify a second machine that contains content for transfer to the first machine, but utilizing a proxy to maintain anonymity. FIG. 3 shows a system 300, which may be part of system 100 of FIG. 1, where machine 301 interacts with machine 302 via network 320 and registry 310. Machines 301 and 302 may be any of the devices shown in FIG. 1 or 2, or any other device. Machine 301 registers with registry 310 either directly or via network 320. Likewise machine 302 registers with registry 310 either directly or via network 320. An entry 311 in registry 310 contains device ID, address and characteristics of machine 301 and an entry 312 contains device ID, address and characteristics of machine 302.

Either a device search or content search may be performed, equivalent to system 200 of FIG. 2. Assuming content 303 of machine 302 is to be accessed for download, a search is conducted by machine 301 and access sought for establishing the connection for the interaction. However, in this instance machine 302 is setup so that it's address remains anonymous. Machine 301 searching for content 303 of machine 302 is not provided with the address. Instead, a proxy 313 is used so that machine 302′s address is maintained anonymous. Thus, interaction is provided via proxy 313 and access granted to content 303 for download either directly or indirectly to machine 301.

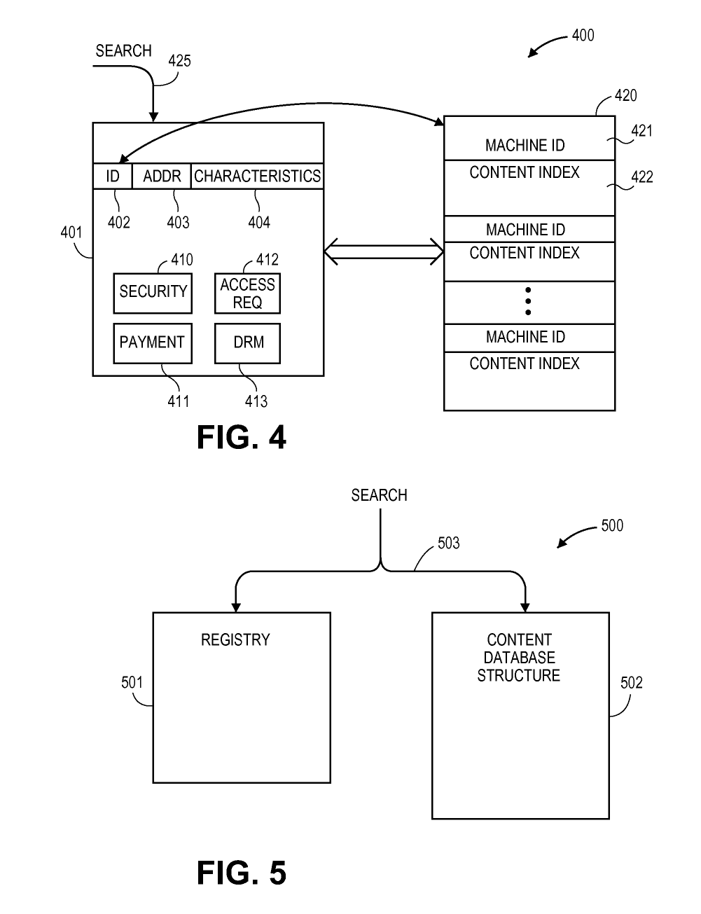

FIG. 4 is an example diagram of a registry that contains a list of registered machines and supporting a content search, in which the content is associated with a machine registered in the registry. FIG. 4 shows a system 400 that includes a registry 401 and associated content storage (or database) 420. Registry 401 may be registry 121 and content storage 420 may be content/index storage 122 of FIG. 1. The above-described device registration registers device ID 402, address (ADDR) 403 and characteristics 404 of a particular device as an entry in registry 401.

Storage 420 may contain content or index of the content for various registered devices. Generally, the registered devices would upload content index into storage 420 for purposes of identifying content that is to be shared. It is to be noted that the actual content may be uploaded into storage 420, but to limit storage, some form of content index, metadata, etc. is uploaded for providing a catalog of content available at that respective device. It is also to be noted that the content index may be obtained by a search engine searching the index of individual registered devices and pulling the index of shared content from those devices into storage 420. A caching technique may be used as well.

The stored content index is identified with a corresponding machine ID 421 so that the content index 422 for that machine is capable of being cross-referenced with device ID 402 in registry 401. In this way, the content index may be kept separate from the registry entries. However, it is to be noted that the content index may be merged with the registry entry in other embodiments.

Also shown as part of registry 401 are a number of functional modules that perform certain functions. These functions may be specified in the characteristics. A security module 410, payment module 411, access request 412 and DRM 413 are shown as examples. Other embodiments may have a different functional module makeup. Furthermore, the modules may be within registry 401, a search engine of registry 401 or at some other location.

The functional modules perform a particular function when specified by a requirement noted in the characteristics. Thus, for example, when search 425 using a search parameter is seeking access to a device noted in ID 402 to download content, an element in characteristics 404 may invoke one or more of the functional modules. For example, if the search is to locate and download content from a content provider in which the searching party has access rights through a protected account, access request module 412 may request access information to permit access to the searchers account, security module 410 may then provide a secure connection, and payment module 411 may charge the account for the download and DRM module may ensure that only a certain number of downloads are permitted. Other examples abound on the additional functions that may be provided by specifying such functions in the characteristics.

FIG. 5 is an example diagram of a search in which a registry that contains a list of registered machines is searched along with a separate search for content that is associated with a machine registered in the registry. In FIG. 5, system 500 is shown having a separate registry 501 and content database structure (storage) 502, which may contain the actual content or the content index. In this example, a search parameter 503 is received and a search is performed in registry 501 and content database 502 in parallel. The search may contain search data that may hit in both structures. Thus, matches to the search that results in a hit in registry 501 and content database 502 may be correlated to obtain the result(s) in response to the search.

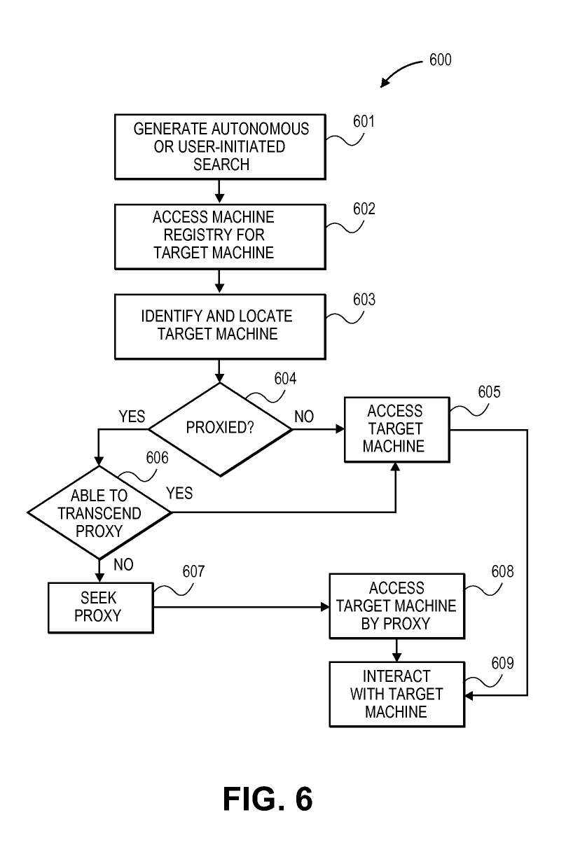

FIG. 6 is an example flow diagram in conducting a search to identify and locate a target machine registered in a machine registry. In conducting a search of a machine-based search engine, the search parameter may be initiated autonomously or by user input. As shown in flow diagram 600, the search is generated (block 601) to access the machine registry for a target machine (block 602). Note that the search may be for the target content, but that search still entails a search (cross-reference) to the search registry to locate the device address. The search identifies and locates the address of the target machine and the profile data and/or the status data of the target machine (block 603). Then a check is made to determine if the target machine requires a proxy (block 604). If proxy service is not required, the identified target machine is accessed (e.g. content download) (block 605). If proxied, then the characteristics may be checked to determine if the connection may transcend the proxy, such as by passing access requirements, making payment, etc. (block 606). If yes, then access to the target machine is granted (block 605), otherwise the connection to the target machine is proxied (block 607) to access the target machine (block 608) to maintain anonymity of the target machine. Subsequent to obtaining access, either by proxy or without, the two machines may interact (block 609).

Generally, software programs and apps on devices (such as those shown in FIG. 1) and/or the machine-based search engine may provide the various steps shown in FIG. 6. FIG. 6 shows one example process for the interaction between two machines and it is to be noted that other embodiments may perform different steps.

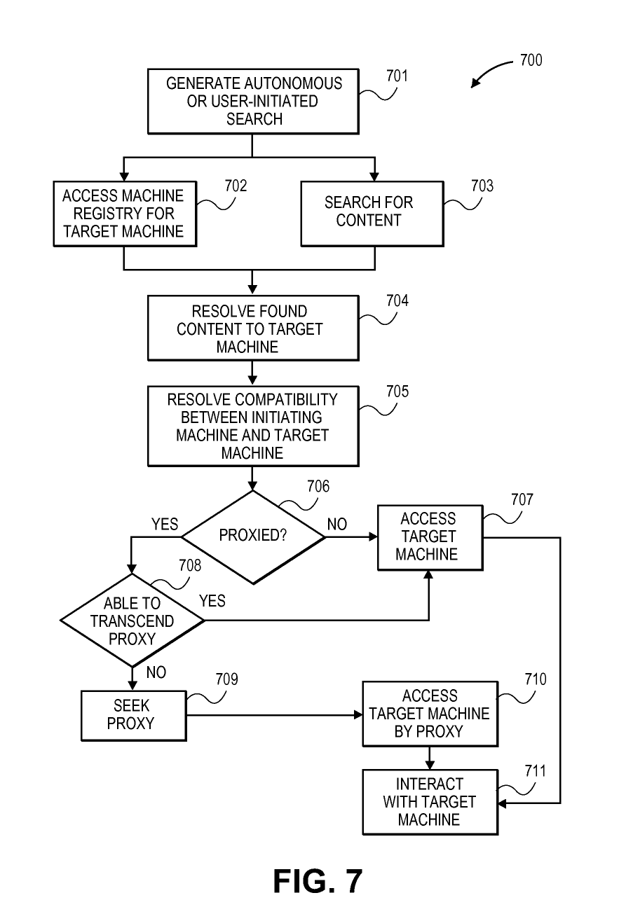

FIG. 7 is an example flow diagram in conducting a search to identify and locate a target content for a machine registered in a machine registry. Flow diagram 700 of FIG. 7 is similar to flow diagram 600, but the search is bifurcated for device search and content search, as noted for system 500 of FIG. 5. In conducting a search of a machine-based search engine, the search parameter may be initiated autonomously or by user input. As shown in flow diagram 700, the search is generated (block 701) to access the machine registry for a target machine (block 702) and to perform a content search in a content database (block 703). The search may identify and locate the address of the target machine (block 702) and/or find content in the content database (block 703). Then, the search results are resolved and the profile data and/or the status data of the target machine identified (block 704).

Then, one or more compatibility issues may be resolved for the two machines (block 705). For example, if one machine is incapable of interacting with the other (based on the profile data and/or the status data), the content is incompatible for use by the requesting machine, the content formats are incompatible, the programs of the two machines for consuming the content are not compatible, etc., then compatibility issues may be resolved at this juncture (block 705). This may entail putting the content in another format (e.g. audio instead of text).

Then, a check is made to determine if the target machine requires a proxy (block 706). If proxy service is not required, the identified target machine is accessed (e.g. content download) (block 707). If proxied, then the characteristics may be checked to determine if the connection may transcend the proxy, such as by passing access requirements, making payment, etc. (block 708). If yes, then access to the target machine is granted (block 707), otherwise the connection to the target machine is proxied (block 709) to access the target machine (block 710) to maintain anonymity of the target machine. Subsequent to obtaining access, either by proxy or without, the two machines may interact (block 711).

As noted above, generally, software programs and apps on devices (such as those shown in FIG. 1) and/or the machine-based search engine may provide the various steps shown in FIG. 7. FIG. 7 shows one example process for the interaction between two machines and it is to be noted that other embodiments may perform different steps. Furthermore, the resolving the compatibility issues may also be performed with the flow diagram 600 of FIG. 6 (although not shown), which compatibility issues may be based on the profile data and/or the status data of the target machine.

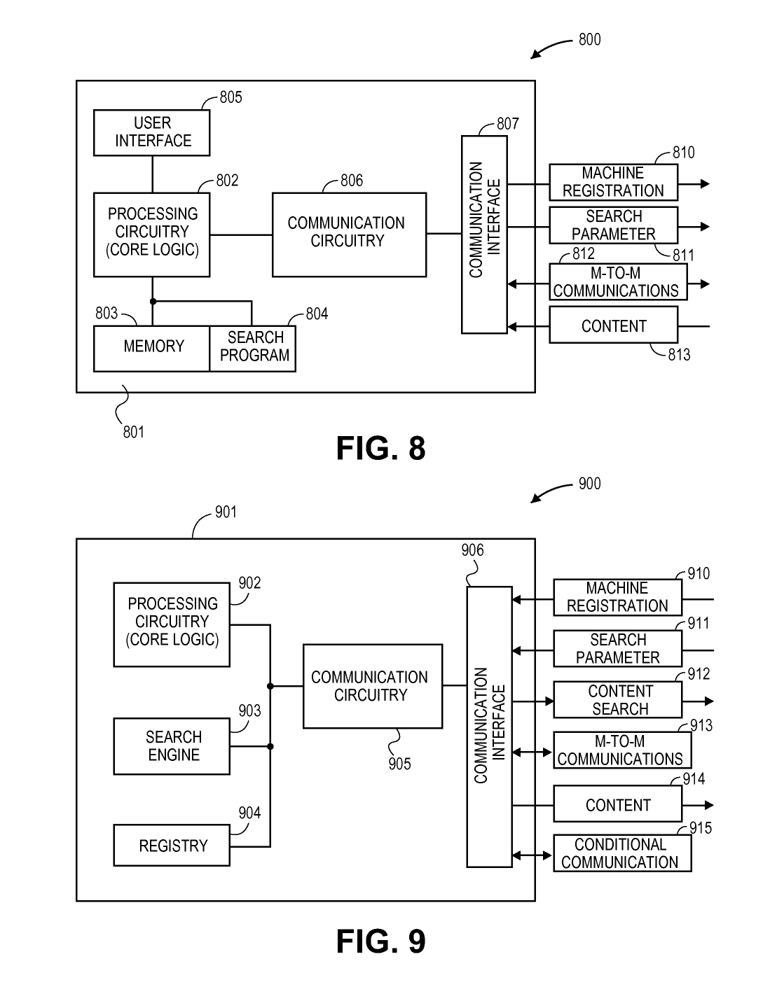

FIG. 8 is an example block diagram of a machine that initiates a search for machine-to-machine interaction. Diagram 800 shows a device 801, which may be one of the devices shown in FIG. 1, or it may be any other device. Device 801 includes a processing circuitry (or core logic) 802 coupled to a memory 803 and a search program (or app) 804, communication circuitry 806 and communication interface 807. Device 801 may also include a user interface 805.

User interface 805 may include one or more input components (e.g. keyboard, touch screen, microphone, etc.) and/or output components (e.g. display, speaker, headphone, etc.) for user interaction with device 801.

Processing circuitry 802 includes one or more core logic components for providing processing functions for device 801. Processing circuitry 802 may also execute programs that initiate device registration with afore-mentioned registries, conduct searches, interact with the search engine and the target device, interact with other devices required for interaction with the target device and download the identified content. When device 801 is operating in an autonomous manner to access the registry and/or the content, processing circuitry 802 also provides the autonomous operation.

Memory 803 may contain various programming instructions to be executed by processing circuitry 802 as well as data. Search program 804 is utilized for the search functions described above. Search program 804 may be an app.

Communication circuitry 806 provides one or more communication related functions, such as coding/decoding, modulation/demodulation, signal conversion, etc. based on the type of communication used. Communication interface 807 then provides the interface for transmission and reception of communication signals to and from device 801. Some of those functions are noted as machine registration 810, search parameter transmission 811 for conducting the search, machine-to-machine communication and interaction 812 and content download 813. It is to be noted that circuit block diagram 800 is just one example and that other embodiments abound for devices that register and conduct searches.

FIG. 9 is an example block diagram of a machine-based search engine and registry that supports a search for machine-to-machine interaction. Diagram 900 shown device 901, which may be an equivalent machine-based search engine shown in FIG. 1, or it may be any other device. Device 901 includes a processing circuitry (or core logic) 902 coupled to a search engine 903 and a registry 904, communication circuitry 905 and communication interface 906.

Processing circuitry 902 includes one or more core logic components for providing processing functions for device 901. Processing circuitry 902 may also execute programs that provide device registration into registry 904 for devices registering with device 901, interact with search engine 903 to perform searches, interact with other devices required for machine-to-machine interaction, support other functions required of the characteristics field of the device registry, and support compatibility resolution for machine-to-machine interaction.

Communication circuitry 905 provides one or more communication related functions, such as coding/decoding, modulation/demodulation, signal conversion, etc. based on the type of communication used. Communication interface 906 then provides the interface for transmission and reception of communication signals to and from device 901. Some of those functions are noted as machine registration 910, search parameter reception 911 for conducting the search, initiating content search 912, machine-to-machine communication and interaction 913 and content transmission 914 and conditional communication 915, such as seeking proxies, executing functional modules as specified for interactions and supporting compatibility. It is to be noted that circuit block diagram 900 is just one example and that other embodiments abound for devices that operate as machine-based search engines.

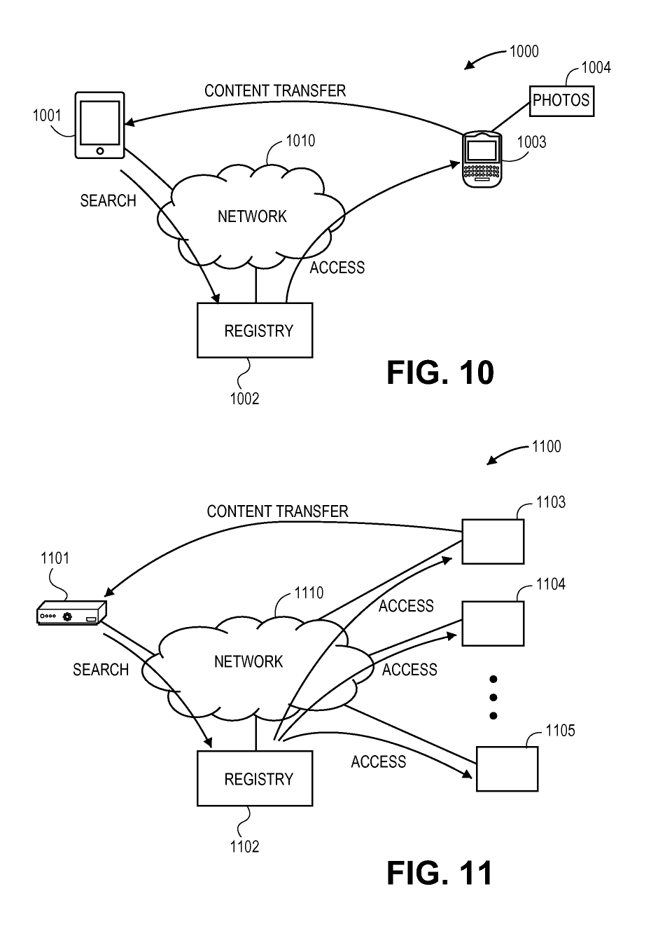

FIG. 10 is a system diagram illustrating an example of content transfer via machine-to-machine interaction, when a target machine is identified by using the registry that supports machine-based searching. In this particular example, system 1000 shows a tablet 1001 attempting to access mobile phone 1003. This scenario is similar to the example described with the grandmother's mobile phone. Tablet 1001 and mobile phone 1003 are registered with registry 1002 either directly or via network 1010. When a device search or content search is initiated by tablet 1001, tablet 1001 accesses registry 1002 via network 1010 to locate the device or content. Using the previous grandma's example, tablet 1001 is searching to locate photos 1004 on grandma's mobile phone 1003. Assuming the photos are set for sharing and, therefore, accessible by the search to locate them (whether indexed with the registry or the search engine searching the registered devices for the content), the search will result in a hit. The registry is then used to determine if any conditions or functions are to be executed to effect the interaction, and after meeting the conditions, completes the connection (whether proxied or non-proxied) so that machine-to-machine interaction (M2) may occur.

With autonomous machine-to-machine interaction, tablet 1001 may conduct the search and obtain the content without user input (other than the user-initiated input relating to photos 1004 on grandmother's mobile phone 1003). The user of tablet 1001 after initiating the search may rely on tablet 1001 and the search engine to conduct the search and download the photos. For example, if mobile phone 1003 is currently not active (e.g. turned off or out of range), then the programming may set a condition for the photos to be downloaded when mobile phone 1003 is active or accessible again. Photos 1004 may be downloaded to tablet 1001. If tablet 1001 is not active during the download, registry 1002 may download photos 1004 and store the photos until tablet 1001 is active again. Note that the content transfer may be via network 1010, or via some other network.

In this scenario, it may be that the user of tablet 1001 may need to provide a password or some other access requirement before photos 1004 are released for download to tablet 1001. Such conditions may be specified in the characteristics field provided for the registered device in registry 1002.

Furthermore, since mobile phone 1003 is a mobile device, as well as tablet 1001, it is possible that the address noted in registry 1002 for either of the devices may change as the devices roam to a different location. In this instance, it is possible that the address noted in the registry for a device may not be current. In that instance, mobile devices may need to access the registry periodically to inform the registry as to the device's current address.

FIG. 11 is a system diagram illustrating an example of content transfer via machine-to-machine interaction, when target content is identified in one or more machines by using the registry that supports machine-based searching. FIG. 11 shows a system 1100 in which a set-top box (STB) 1101 and a plurality of content service providing machines 1103-1105 are registered with registry 1102. In this scenario STB 1101 is capable of accessing different content providers via network 1110. STB 1101 also has programming intelligence to identify programs watched by a user of the STB. Without user interaction, STB 1101 notes that the viewer has an inclination to watch black and white science-fiction movies. With this information, the programming of STB autonomously connects to registry 1102 and has the search engine search for black and white science-fiction movies from various registered content providers 1103-1105. When such content is found, the STB provides a list of such content to the viewer at an appropriate time. If some of the content are free of cost, STB 1101 may download the content and inform the viewer of the downloaded content. For content that requires payment, STB 1101 may inform the viewer as to that fact, or even provide the cost figures to the viewer. Note that content transfer may be via network 1110, or via some other network.

Furthermore, in some instances, the format of the content may not be presentable on a device. For example, a device may accept a streaming video of a first format, but may not be able to accept the video in a second format. In this instance, the characteristics registered for one device and the characteristics of the device having the content may be compared for compatibility. Where compatibility is not present, the machine or the search engine may make the decision not to acquire the content or, at least, inform the party conducting the search. In other instances, a search may be conducted to resolve the compatibility issues.

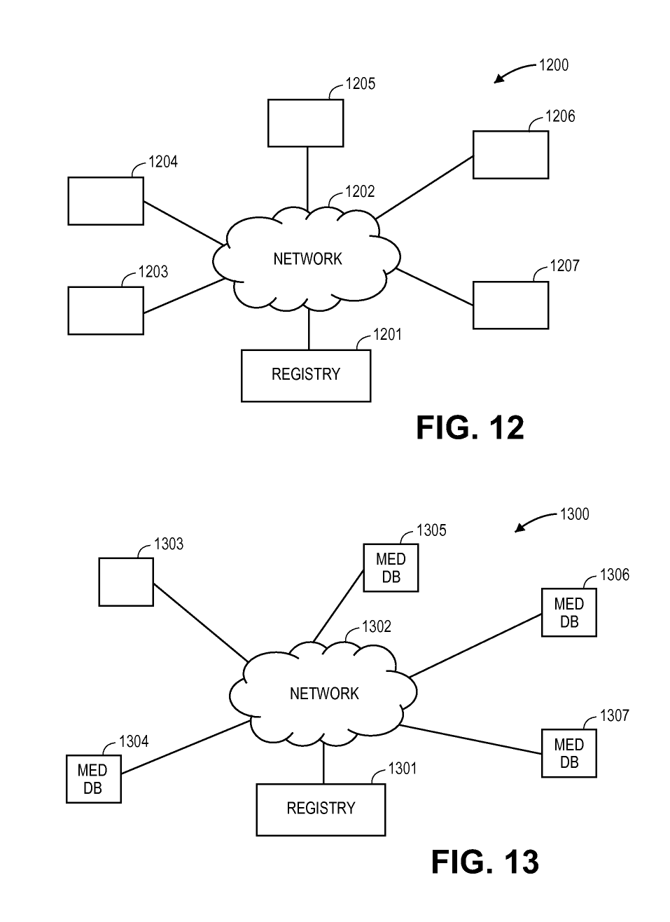

FIG. 12 is a system diagram illustrating an example of content transfer via machine-to-machine interaction in an industrial setting. In FIG. 12, system 1200 shows a plurality of locations (such as buildings or factories) 1203-1207 that connect to registry 1201 via network 1202. In this scenario, the businesses and/or factories associated with a particular group (e.g. same company, similar industrial group, performing similar tasks) are registered with registry 1201 to share content or exchange information. In this example, once a machine registers with registry 1201, it is now capable of supporting information exchange with other machines at locations 1203-1207. The manner of exchange or other requirements for interaction may be set in the characteristics that are uploaded to the registry.

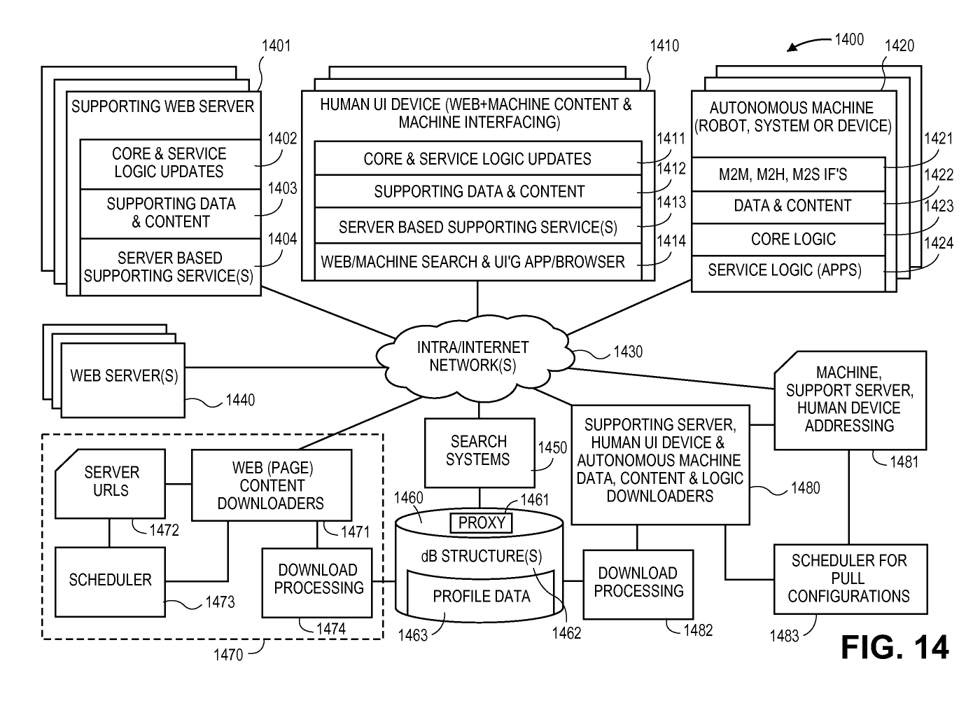

FIG. 13 is a system diagram illustrating an example of content transfer via machine-to-machine interaction in a medical setting. In FIG. 13, system 1300 shows a plurality of medical databases 1304-1307 connected to registry 1301 via network 1302. The medical databases may be at hospitals, doctor's offices, research facilities, universities and other medical related places. The databases provide medical related content for data sharing or exchange. A machine 1303 joining the group may register with registry 1301 to participate in obtaining this information. For example, a doctor joining this group may have access to considerable amount of information from the various databases.

In another scenario, related to system 1300, not only are medical databases connected to the group, medical devices are also connected to the registry. The medical devices themselves may access the database to provide information or obtain information. For example, a medical device such as an X-Ray machine may connect to the registry to autonomously search through a database of X-ray images looking to compare a patient's X-ray image to make a diagnostic comparison of the patient's condition and/or inform the patient's doctor as to other cases having similar symptoms.

FIG. 14 shows a system diagram of an example network integrating the machine-based search engine and registry with web-based content searching. FIG. 14 shows a system 1400 that integrates the above-described machine-to-machine infrastructure with the search infrastructure currently in practice. System 1400 of FIG. 14 includes a plurality of devices 1420 that are configured to operate as autonomous machines (e.g. robot system or device) as described above in conducting machine-to-machine interaction. Devices 1420 may include devices described above, such as devices 101-108 of FIG. 1, that perform the machine-to-machine interaction. A respective one of devices 1420 may include one or more of core logic (processing circuitry) 1423, service logic (e.g. apps) 1424 and an interface 1421 to provide machine-to-machine (M2M), machine-to-human (M2H) and/or machine-to-server (M2S) interaction(s). Interface 1421 may also include hardware, software or firmware to provide the interaction in interfacing to machines, humans and/or servers. Data and/or content 1422 may be present as well.

A machine-based search engine may include a machine support server 1481, download server 1480, scheduler 1483 and a download processing module 1482. Support server 1481 operates similar to registries described above (e.g. registry 121) to register devices 1420 and provide the addressing for the registered devices. Download server 1480 operates to support various downloading functions for autonomous and/or human-interacted downloads. Download processing module 1482 operates on downloaded data or content for placing into a database (DB) structure storage. Scheduler 1483 may be present to schedule the pulling of the content, including scheduling time for delayed pulling of the content, such as when a device containing the content is not active.

Devices that employ user-initiated searches via a user interface (UI) are shown as devices 1410. In an integrated system where user-initiated searches may be conducted, devices 1410 may provide the manual search as well as a combination of manual and autonomous searches. A respective device 1410 may include core and service logic 1411 and server based support services 1413 for conducting user searches. Web browsers, apps and other search programs may be present as shown in browser module 1414. Data and content 1412 may be present as well.

Devices 1410 may utilize existing techniques for user-initiated manual searches, autonomous searches based on user-initiated search parameters, or a combination of both. Thus, devices 1410 may also register with support server 1481 to utilize the functions available for registered devices to use the download server 1480.

Existing systems or comparable techniques that provide equivalent functions for operating on user-initiated searches may be integrated with the scheme for device ID registration. Thus, search systems 1450 may operate to access web servers 1440 to provide searches to locate URL addresses of searched sites. A crawler 1470 may also be present to provide web crawling tasks and to download content associated with web sites, utilizing a web page content downloader 1471. A server 1472 may be used to identify and cache searched URLs. A scheduler 1473 may also be present to schedule conventional web downloads. A download processing module 1474 may be present to process the downloaded content for storing in DB structure(s) 1462.

The content or index of the content retrieved may be retained by one or more DB structures 1462 of storage unit 1460. It is to be noted that separate DBs may be used for searches conducted by downloader 1480 and downloader 1471. The profile data 1463 for machines, such as device ID, address and characteristics, may be stored in storage 1460, as well. Likewise, proxy information 1461 to provide the proxy connection may be stored in storage 1460.

In some instances, supporting web servers 1401 may be used as well to complement or provide equivalent functions as devices 1420 and/or 1410. Supporting servers 1401 may perform web based searches, but may also provide machine-to-machine interaction as well by registering with machine support server 1481. Supporting servers may include core and service components 1402 and server support services 1404. Supporting servers 1401 may also support data and content transfers 1403 as well. Thus, servers may participate in various machine-to-machine interactions as well and such operations are not limited to end user devices.

A network 1430 may be used to tie in the various components. As noted above, a variety of networks that utilize wired, wireless or optical connections, or any combinations thereof, may be employed for network 1430. Network 1430 may be public (e.g. Internet), private (e.g. intra-network), virtual, or any combination thereof. The devices on the network may utilize one or more communication protocols and addressing schemes to communicate via the network. Although one network is shown, it is to be noted that network 1430 may include multiple networks.

Thus, search infrastructure supporting identification, setup and maintenance of machine-to-machine interactions is described. The interactions between machines may be automatic (without user intervention) or the interactions may be automated (with user action). The interaction between two machines may be performed autonomously, in that a machine triggers an action or response to link to another machine. Furthermore, the interaction may be between two or more unassociated machines.

Furthermore, billing support, such as revenue collection, may be provided by one or more machines when an interaction is executed. For example, when a content transfer occurs, one of the machines involve in the content transfer, or even a third machine, may generate revenue collection information related to the content transfer. Similarly, digital rights management (DRM) requirements may be imposed as well in the performance of the interaction by one or more of the machines.

The embodiments above have been described with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

As may also be used herein, the terms “processor,” “processing circuitry,” “core logic” and/or “service logic” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Some of the processing functions may be performed by software.

Furthermore, such processing components may include, or configured to operate with, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information.

What is claimed is:

1. A method performed by a search infrastructure for supporting machine-to-machine interaction between a plurality of unassociated machines of a corresponding plurality of users, in which respective of the plurality of unassociated machines having machine profile data, the method comprising:
receiving a first search input autonomously generated by a first machine of the plurality of unassociated machines;
generating a first search output identifying at least a second machine of the plurality of unassociated machines, the first search output being based at least in part on the first search input and the machine profile data of the second machine; and
assisting in associating the first machine and the second machine.

2. The method of claim 1, wherein the assisting in associating comprises assisting in establishing a working relationship between the first machine and the second machine.

3. The method of claim 1, wherein the generating of the first search output is also based on the machine profile data of the first machine.

4. The method of claim 1, wherein status data of the plurality of unassociated machines is maintained by the search infrastructure.

5. The method of claim 4, wherein the generating of the first search output is also based on the status data.

6. The method of claim 4, wherein the status data comprises current addressing data.

7. The method of claim 4, wherein the status data comprises operational characteristics data.

8. The method of claim 1, wherein the assisting in associating comprises participating in establishing a secure interaction between the first machine and the second machine.

9. The method of claim 1, wherein the assisting in associating comprises participating in authorization processing required by the second machine

10. The method of claim 1, wherein the first search output includes at least some status data of the second machine.

11. The method of claim 2, wherein the working relationship comprises a support processing relationship.

12. The method of claim 2, wherein the working relationship comprises a data delivery relationship.

13. The method of claim 1, wherein the assisting in associating comprises assisting in revenue collections associated with services rendered by the second machine.

14. The method of claim 1, wherein the assisting in associating comprises assisting in revenue collections associated with services rendered by the first machine.

15. The method of claim 1, wherein the assisting in associating comprises supporting underlying rights management.

16. A method for supporting autonomous machine-to-machine interaction between machines based on characteristics of the machines comprising:
receiving a search parameter from a first machine to access a registry that contains a list of a plurality of machines, profile data of the plurality of machines, respective addresses of the plurality of machines and respective characteristics associated with the plurality of machines, in which the first machine is one of the plurality of machines;
performing a search based on the search parameter to identify a second machine from the list of the plurality of machines that meets the search parameter, in which the characteristics associated with the plurality of machines are accessed for meeting a requirement of the search parameter;
identifying profile data of the second machine;
identifying an address for the second machine; and
supporting interaction between the first and second machines based on the address for the second machine provided by the list, in which the interaction between the first and second machines is determined by the respective characteristics of the second machine and in which the interaction is performed as a machine-to-machine interaction.

17. The method of claim 16, wherein the search parameter includes a search for a particular machine, wherein the characteristics associated with the plurality of machines in the list includes an identifying element that is associated with the second machine and searchable by the search parameter.

18. The method of claim 16, wherein the search parameter includes a search for a particular content, wherein the characteristics associated with the plurality of machines in the list includes an identifying element that is used to associate the second machine with the particular content.

19. An apparatus to support autonomous machine-to-machine interaction between machines for content transfer comprising:
a communication interface configured to operate via a network to communicate with a plurality of machines and to receive a search parameter from a first machine;
a registry that contains a list of the plurality of machines, profile data of the plurality of machines, respective addresses of the plurality of machines and respective characteristics associated with the plurality of machines, in which the first machine is one of the plurality of machines;
a search engine configured to perform a search based on the search parameter from the first machine to identify content that meets the search parameter; and
core logic configured to associate content identified in the search to a second machine listed in the plurality of machines, identify profile data of the second machine and identify an address for the second machine, and the core logic, via the communication interface, is configure to support interaction between the first and second machines to transfer content, in which the interaction between the first and second machines is determined by the respective characteristics of the second machine and in which the interaction is performed as a machine-to-machine interaction.

20. The apparatus of claim 19, wherein the interaction is to support content transfer between the first and second machines via a proxy.
